(19) United States
(12) Patent Application Publication
(10) Pub. No.: US 2018/0226077 A1
(43) Pub. Date: Aug. 9, 2018

(54) VEHICLE DRIVING ASSIST AND VEHICLE HAVING SAME

(71) Applicant: LG Electronics Inc., Seoul (KR)

(72) Inventors: Sungha CHOI, Seoul (KR); Seyoung LEE, Seoul (KR); Dongwook KIM, Seoul (KR); Yunhui PARK, Seoul (KR)

(21) Appl. No.: 15/750,455

(22) PCT Filed: Aug. 18, 2015
(86) PCT No.: PCT/KR2015/008602

§ 371 Date: Feb. 5, 2018

(30) Foreign Application Priority Data
Aug. 5, 2015 (KR) 10-2015-0110724

(51) Int. Cl. G10L 15/22; B60R 16/023; B60K 35/00; G06F 3/0482; G06F 3/16

(52) U.S. Cl. CPC G10L 15/22; B60R 16/023; B60K 35/00; G06F 3/0482; G10L 2015/223; B60K 2350/962; B60K 2350/1044; B60K 2350/1096; G06F 3/167

(57) ABSTRACT

The present invention relates to a vehicle driving assist interoperating with a plurality of mobile terminals and a vehicle equipped with the same, the vehicle driving assist comprising: a display unit; a microphone configured to receive voice uttered by a user in a vehicle; a wireless communication unit, disposed inside the vehicle, configured to wirelessly communicate with a plurality of mobile terminals; a position sensing unit for sensing the positions of the plurality of mobile terminals within the vehicle; and a controller for transmitting voice data to any one of the plurality of mobile terminals through the wireless communication unit so that the voice data corresponding to the voice inputted from the microphone can be processed, wherein the plurality of mobile terminals process the voice data through different voice recognition algorithms.

### TECHNICAL FIELD

The present invention relates to a vehicle driving assist interoperating with a plurality of mobile terminals and a vehicle having the same.

### BACKGROUND ART

Terminals may be divided into mobile/portable terminals and stationary terminals according to mobility. Also, the mobile terminals may be classified into handheld types and vehicle mount types according to whether or not a user can directly carry.

As it becomes multifunctional, a mobile terminal can be allowed to capture still images or moving images, play music or video files, play games, receive broadcast and the like, so as to be implemented as an integrated multimedia player.

Meanwhile, a lot of vehicle automation technologies have been developed with the progress of electronic technology. Also, various features for assisting the driver in driving have been developed in line with vehicle electronics technology. These technologies are generally referred to as “Advanced Driver Assistance Systems (ADAS)”.

Vehicle control via voice recognition is being developed as a way to assist a vehicle's driving. However, there are limitations when it comes to recognizing voice only by a voice recognition engine equipped in a vehicle.

To overcome these limitations, the present invention proposes a method for performing and processing voice recognition via a mobile terminal interoperating with a vehicle driving assist.

### DISCLOSURE OF THE INVENTION

Therefore, an object of the present invention is to provide a method for controlling a vehicle by performing a voice recognition function via a plurality of mobile terminals interoperating with the vehicle.

Another object of the present invention is to provide a method for controlling a vehicle depending on the position of an utterance in the vehicle.

To achieve these and other advantages and in accordance with the purpose of the present invention, as embodied and broadly described herein, there is provided a vehicle driving assist including: a display unit; a microphone configured to receive an utterance from a user in a vehicle; a wireless communication unit configured to wirelessly communicate with a plurality of mobile terminals positioned in the vehicle; a position sensing unit for sensing the positions of the plurality of mobile terminals in the vehicle; and a controller for transmitting voice data corresponding to the utterance received by the microphone to one of the plurality of mobile terminals so as to process the voice data, wherein the plurality of mobile terminals process voice data through different voice recognition algorithms.

The controller controls the display unit to display a plurality of graphical objects respectively representing the plurality of mobile terminals, and displays the graphical object representing the mobile terminal that has received the voice data in such a way as to be visually distinctive from the other graphical objects.

The controller detects a mobile terminal for receiving the voice data, among the plurality of mobile terminals, according to a preset condition.

The preset condition is a condition relating to at least one among the mobile terminal's resources, the mobile terminal's position, and the mobile terminal's voice recognition engine type.

The controller transmits the voice data to a mobile terminal corresponding to one of the plurality of graphical objects selected by the user so that the voice data is processed via the mobile terminal.

The controller controls a mobile terminal corresponding to one of the plurality of graphical objects to be restricted from voice reception via the microphone, based on a preset type of touch on the graphical object.

A graphical object associated with a function for controlling the microphone to receive an utterance from a particular position in the vehicle is displayed on the display unit, and the controller controls the microphone to receive an utterance from the particular position, based on a touch on the graphical object associated with the microphone control function.

The controller processes a control command corresponding to the utterance, based on the position of the utterance.

The vehicle is divided into a plurality of virtual sections, and the controller controls a particular section including the position of the utterance, among the plurality of virtual sections, based on the control command corresponding to the utterance.

If the control command corresponding to the utterance is a control command for controlling a section other than the particular section including the position of the utterance, the controller restricts the execution of the control command corresponding to the utterance.

The controller displays on the display unit a graphical object representing the position of the utterance.

The controller blocks the reception of the utterance, in response to a touch on the graphical object representing the position of the utterance.

The controller displays on the display unit vehicle control result information based on a vehicle control command.

If the result information is privacy information, the controller restricts the display of the result information.

The plurality of mobile terminals are mobile terminals interoperating with the vehicle driving assist via wireless communication.

Another embodiment of the present invention provides a method for controlling a vehicle driving assist, including: receiving an utterance from a user in a vehicle; transmitting voice data corresponding to the utterance to a specific one of a plurality of mobile terminals positioned in the vehicle so as to process the voice data via the specific mobile terminal; receiving a vehicle control command generated based on the processed voice data from the specific mobile terminal, after transmitting the voice data; and performing vehicle control based the received vehicle control command.

The plurality of mobile terminals process voice data through different voice recognition algorithms.

The specific mobile terminal is determined as selected by the user or according to a preset condition.

In the performing of vehicle control, the vehicle is controlled based on the position of the utterance.

In the performing of vehicle control, the vehicle components included in a section adjacent to the position of the utterance are controlled.

The present invention can process voice data corresponding to an utterance made in a vehicle by using a voice recognition function set up on a plurality of mobile terminals. As such, the present invention can increase the accuracy of the voice recognition function by recognizing voice through various voice recognition algorithms.

Moreover, the present invention can perform control on the inside of the vehicle depending on the position of an utterance in the vehicle. As such, a user in the vehicle is able to control vehicle components in the section they are positioned via voice.

### BRIEF DESCRIPTION OF THE DRAWINGS

FIG. 1A is a block diagram illustrating a vehicle control device related to the present invention.

FIG. 1B is a block diagram showing a telematics terminal system according to an embodiment disclosed in the present specification.

FIG. 1C is a block diagram showing a configuration of a telematics terminal according to an embodiment of the present invention.

FIGS. 2A and 2B are conceptual diagrams illustrating the relationship between a vehicle driving assist according to the present invention and a mobile terminal.

FIG. 3 is a flowchart of a method for controlling a vehicle via voice in a vehicle driving assist that assists the vehicle's driving.

FIGS. 4A, 4B, and 4C are conceptual diagrams showing the control method of FIG. 3.

FIGS. 5A, 5B, and 5C are conceptual diagrams showing a control method for determining a mobile terminal for processing voice data corresponding to an utterance from a user, among a plurality of mobile terminals positioned in a vehicle.

FIG. 6 is a conceptual diagram showing a method for restricting a voice recognition function on a plurality of mobile terminals positioned in a vehicle.

FIGS. 7A and 7B are conceptual diagrams showing a method for controlling a microphone to receive an utterance from a specific user among a plurality of users positioned in a vehicle.

FIGS. 8A and 8B are conceptual diagrams showing a method for disabling a voice recognition function running on a mobile terminal.

FIGS. 9A, 9B, and 9C are conceptual diagrams showing a method for controlling a vehicle based on the position of an utterance.

FIGS. 10A and 10B are conceptual diagrams showing a method for performing natural language processing in a vehicle driving assist.

FIG. 11 is a conceptual diagram showing a method for displaying result information on a display unit after performing a voice recognition function.

### MODES FOR CARRYING OUT THE PREFERRED EMBODIMENTS

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In describing the present disclosure, if a detailed explanation for a related known function or construction is considered to unnecessarily divert the gist of the present disclosure, such explanation has been omitted but would be understood by those skilled in the art. The accompanying drawings are used to help easily understand the technical idea of the present disclosure and it should be understood that the idea of the present disclosure is not limited by the accompanying drawings. The idea of the present disclosure should be construed to extend to any alterations, equivalents and substitutes besides the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the another element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

The vehicle described herein may be a vehicle capable of sensing information related to various environments around the vehicle and thus performing electronic control.

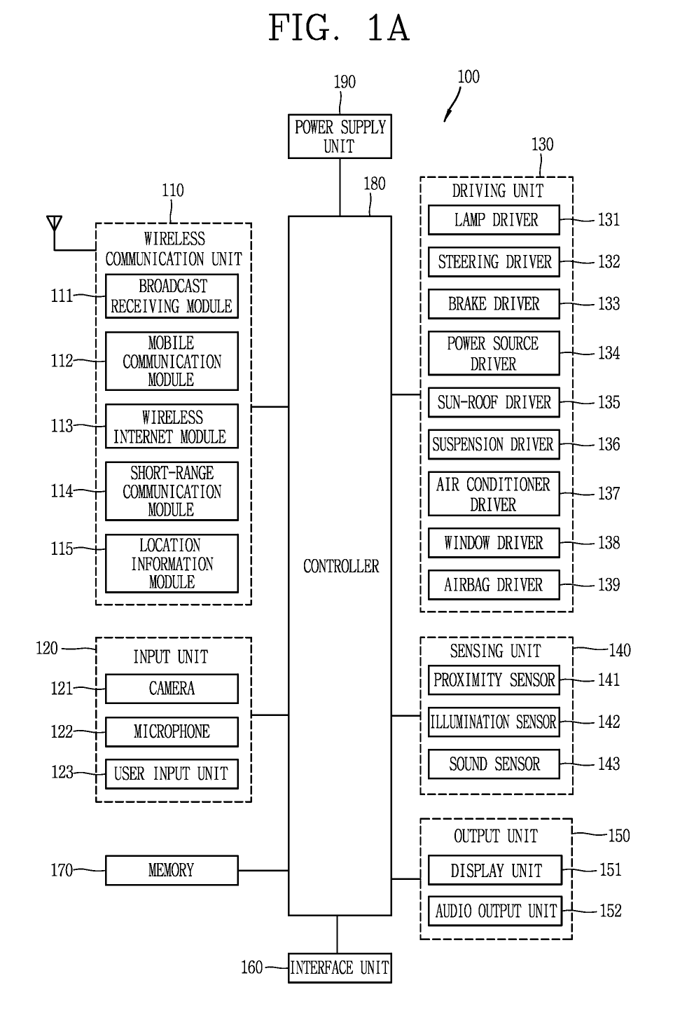

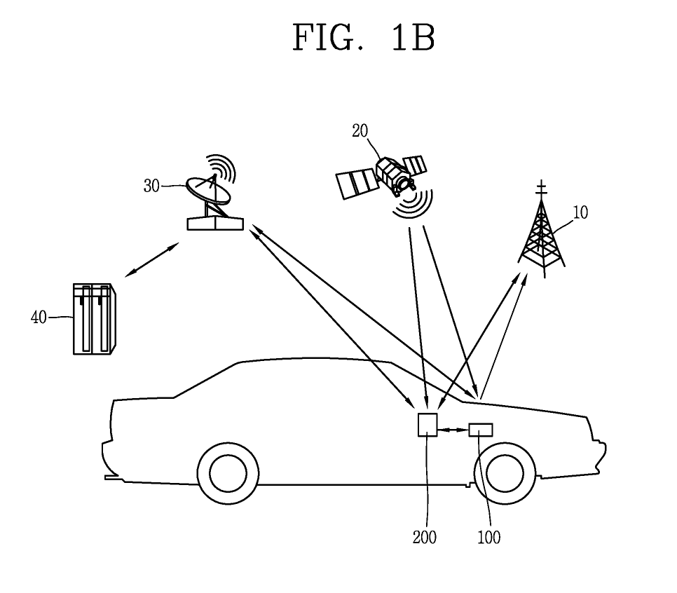

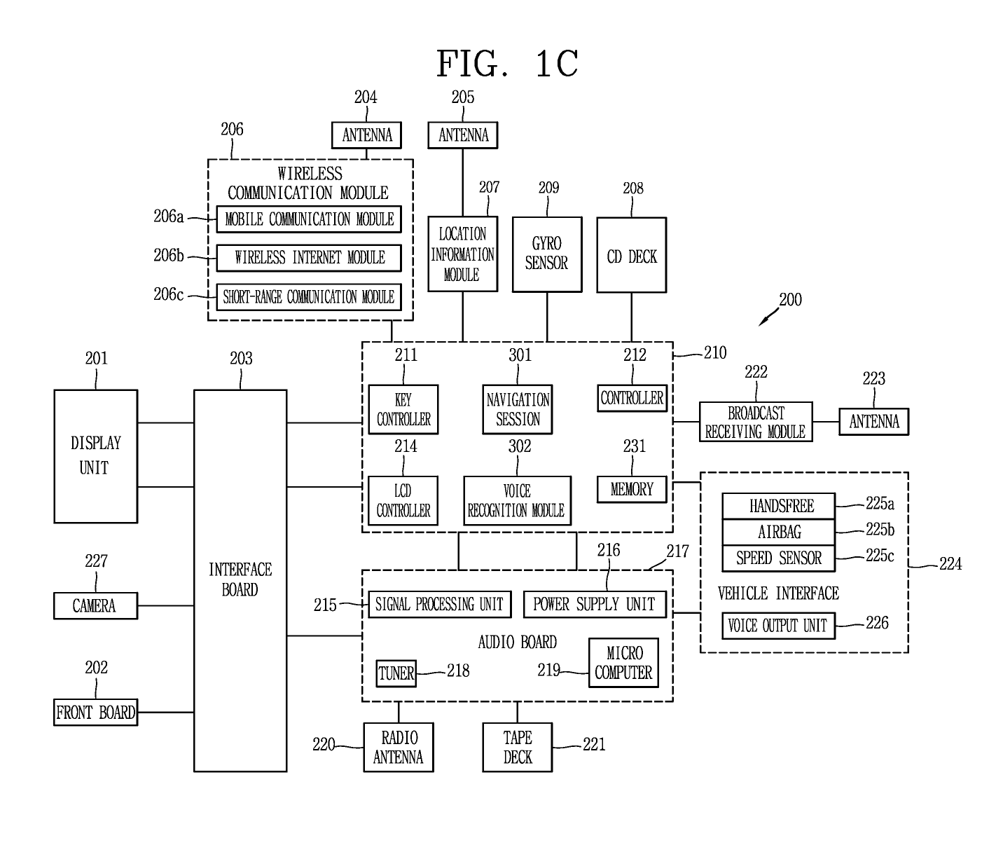

FIG. 1A is a block diagram of a vehicle control device in accordance with one exemplary embodiment of the present invention.

The vehicle control device 100 may be shown having components such as a wireless communication unit 110, an input unit 120, a drive unit 130, a sensing unit 140, an output unit 150, an interface unit 160, a memory 170, a controller 180, and a power supply unit 190. It is understood that implementing all of the illustrated components in FIG. 1A is not a requirement, and that greater or fewer components may alternatively be implemented.

In more detail, among others, the wireless communication unit 110 may typically include one or more modules which permit communications such as wireless communications between the vehicle control device 100 and a vehicle, communications between the vehicle control device 100 and a wireless communication system, or communications between the vehicle control device 100 and an external server. Further, the wireless communication unit 110 may typically include one or more modules which connect the vehicle control device 100 to one or more networks.

The wireless communication unit 110 may include one or more of a broadcast receiving module 111, a mobile communication module 112, a wireless Internet module 113, a short-range communication module 114, and a location information module 115.

The wireless communication unit 110 may exchange data with a mobile terminal or a server in a wireless manner. The wireless communication unit 110 may exchange data wirelessly with a mobile terminal of a vehicle driver. As wireless data communication methods, there are various data communication methods such as Bluetooth, WiFi Direct, WiFi, APiX, and NFC.

Also, the wireless communication unit 110 may receive weather information and road traffic condition information, for example, Transport Protocol Expert Group (TPEG) information, from the mobile terminal or the server.

On the other hand, When a user boards a vehicle, a mobile terminal of the user and the vehicle control device 100 may execute pairing through the short-range communication module 114, automatically or according to a user's request.

The input unit 120 may include a camera 121 or an image input unit for obtaining images or video, a microphone 122, which is one type of audio input device for inputting an audio signal, and a user input unit 123 (for example, a touch key, a mechanical key, and the like) for allowing a user to input information. Data (for example, audio, video, image, and the like) may be obtained by the input unit 120 and may be analyzed and processed according to user commands.

The drive unit 130 may control overall components constituting a vehicle. The drive unit 130 may include a lamp drive unit 131, a steering drive unit 132, a brake drive unit 133, a power source drive unit 134, a sunroof drive unit 135, a suspension drive unit 136, an air conditioning drive unit 137, a window drive unit 138, an airbag drive unit 139, and the like.

The lamp drive unit 131 may control turn-on/turn-off of lamps disposed inside or outside the vehicle. Also, the lamp drive unit 131 may control the intensity, direction, etc. of light emitted from a lamp. For example, the lamp drive unit 131 may turn on or turn off a direction indicator lamp, a brake lamp, etc., provided in the vehicle.

The steering drive unit 132 may perform electronic control of a steering apparatus in the vehicle. The steering apparatus may be a user input unit provided in the vehicle to control a movement of a main body of the vehicle. For example, the steering apparatus may become a handle or steering wheel.

The steering apparatus may control the moving direction of the main body of the vehicle based on a user input. For example, as the user turns the steering wheel to the right, the steering apparatus may control the vehicle such that the advancing direction of the vehicle faces the right.

The brake drive unit 133 may perform electronic control of brake equipment in the vehicle. The brake equipment is a component provided to brake the vehicle. The brake equipment may brake the movement of the vehicle by transmitting braking power to wheels and other apparatuses. The brake equipment may include a hand brake, an air brake, an electric brake, etc., based on power for generating the braking power.

The brake drive unit 133 may control the brake equipment such that the braking power generated by the brake equipment is transmitted to the wheels and the other apparatuses. As an example, the brake drive unit 133 may reduce the speed of the vehicle by controlling the movement of a brake disposed at the wheel. As another example, the brake drive unit 133 may control the advancing direction of the vehicle to the left or right by allowing brakes respectively disposed at left and right wheels to operate differently.

The power source drive unit 134 may perform electronic control of a power source in the vehicle. As an example, when a fossil fuel based engine is used as the power source, the power source drive unit 134 may perform electronic control of the engine. Accordingly, the power source drive unit 134 can control the output torque, etc. of the engine. As another example, when an electric-based motor is used as the power source, the power source drive unit 134 may perform control of the motor. Accordingly, the power source drive unit 134 can control the rotating speed, torque, etc. of the motor.

The sunroof drive unit 135 may perform electronic control of a sunroof apparatus in the vehicle. For example, the sunroof drive unit 135 may control the opening or closing of a sunroof of the vehicle.

The suspension drive unit 136 may perform electronic control of a suspension apparatus in the vehicle. For example, when unevenness exists on a road surface, the suspension drive unit 136 may control the suspension apparatus such that vibration of the vehicle is reduced.

The air conditioning drive unit 137 may perform electronic control of an air conditioner in the vehicle. For example, when the temperature inside the vehicle is high, the air conditioning drive unit 137 may control the air conditioner such that cool air is supplied into the vehicle.

The window drive unit 138 may perform electronic control of a window apparatus in the vehicle. For example, the window drive unit 138 may control the opening or closing of left and right windows disposed at sides of the vehicle.

The airbag drive unit 139 may perform electronic control of an airbag apparatus in the vehicle. For example, the airbag drive unit 139 may control the airbag apparatus such that when an accident of the vehicle is sensed, an airbag is blown out.

The sensing unit 140 may include one or more sensors for at least one of in-vehicle information, ambient environment information surrounding the vehicle, and user information. For example, the sensing unit 140 may include at least one of a proximity sensor 141, an illumination sensor 142, a sound sensor 143, a heading sensor, a yaw sensor, a vehicle forward/backward sensor, a wheel sensor, a vehicle speed sensor, a touch sensor, an acceleration sensor, a magnetic sensor, a gravity (G)-sensor, a gyroscope sensor, a motion sensor, an RGB sensor, an infrared (IR) sensor, a finger scan sensor, an ultrasonic sensor, an optical sensor, e.g., a camera (see 121), a microphone (see 122), a battery gauge, an environmental sensor (e.g., a barometer, a hygrometer, a thermometer, a radioactivity sensor, a thermal sensor, a gas sensor, etc.), a chemical sensor (e.g., an electronic nose, a health care sensor, a biometric sensor, etc.), a vehicle body inclination sensor, a battery sensor, a fuel sensor, a tire sensor, and a steering sensor for sensing a rotation degree of the steering wheel. Meanwhile, the vehicle disclosed in this specification may use a combination of information sensed by at least two of these sensors.

In addition, the sensing unit 140 may further include an accelerator pedal sensor, a pressure sensor, an engine speed sensor, an air flow sensor (AFS), an air temperature sensor (ATS), a water temperature sensor (WTS), a throttle position sensor (TPS), a TDC sensor, a crank angle sensor (CAS), etc.

The sound sensor 143 may be a component of the microphone 122, or may be provided independently from the microphone 122. The sound sensor 143 may be formed to sense an audio signal. The audio signal may be a sound generated outside or inside the vehicle. The vehicle disclosed in this specification may use information corresponding to the audio signal sensed by the sound sensor 143.

The output unit 150 may typically be configured to output various types of information, such as audio, video, tactile output, and the like. The output unit 150 may be shown having at least one of a display unit 151, an audio output module 152, a haptic module 153, and an optical output module 154. The display unit 151 may have an inter-layered structure or an integrated structure with a touch sensor in order to implement a touch screen. The touch screen may provide an output interface between the vehicle control device 100 and a user, as well as function as the user input unit 123 which provides an input interface between the vehicle control device 100 and the user.

The display unit 151 may include a cluster or a head up display (HUD) at the front inside the vehicle. Meanwhile, when the display unit 151 is the HUD, the display unit 151 may include a projection module for projecting images onto a front glass of the vehicle control device 100.

The interface unit 160 serves as an interface with various types of external devices that can be coupled to the vehicle control device 100. The interface unit 160, for example, may include any of a vehicle ECU 270, a vehicle sensor 260, wired or wireless ports, external power supply ports, wired or wireless data ports, memory card ports, ports for connecting a device having an identification module, audio input/output (I/O) ports, video I/O ports, earphone ports, and the like. In some cases, the vehicle control device 100 may perform assorted control functions associated with a connected external device, in response to the external device being connected to the interface unit 160.

The memory 170 is typically implemented to store data to support various functions or features of the vehicle control device 100. For instance, the memory 170 may be configured to store application programs executed in the vehicle control device 100, data or instructions for operations of the vehicle control device 100, and the like. Some of these application programs may be downloaded from an external server via wireless communication. Other application programs may be installed within the vehicle control device 100 at time of manufacturing or shipping, which is typically the case for basic functions of the vehicle control device 100 (for example, a road guidance function, a vehicle control function, etc.). It is common for application programs to be stored in the memory 170, installed in the vehicle control device 100, and executed by the controller 180 to perform an operation (or function) for the vehicle control device 100.

The controller 180 typically functions to control overall operation of the vehicle control device 100, in addition to the operations associated with the application programs. The controller 180 may provide or process information or functions appropriate for a user by processing signals, data, information and the like, which are input or output by the aforementioned various components, or activating application programs stored in the memory 170. The controller 180 can be understood as a component executing the same function or a similar function as or to a vehicle electronic control unit (ECU).

Also, the controller 180 may control at least some of the components illustrated in FIG. 1A, to execute an application program that have been stored in the memory 170. In addition, the controller 180 may control a combination of at least two of those components included in the vehicle control device 100 to activate the application program.

The power supply unit 190 can be configured to receive external power or provide internal power in order to supply appropriate power required for operating elements and components included in the vehicle control device 100. The power supply unit 190 may include a battery, and the battery may be configured to be embedded in the terminal body, or configured to be detachable from the terminal body.

FIG. 1B is a block diagram illustrating a telematics terminal system having a communication terminal according to an exemplary embodiment disclosed in this specification.

As shown in FIG. 1B, a vehicle telematics terminal system may include an information providing center 40 for providing traffic information and various data (for example, programs, execution files, etc.), and a telematics terminal 200 mounted in the vehicle for receiving traffic information via a remote wireless communication network 30 and/or a short-range wireless communication network, and providing a road guidance service based upon a GPS signal received via a satellite 20 and the traffic information. Here, examples of the communication network may further include a wired/wireless communication networks, such as a Local Area Network (LAN), a Wide Area Network (WAN) and the like.

Various traffic information (for example, road traffic information or interesting area information) as well as traffic light information are collected via the communication network, and the collected information are processed by the information providing center 40 (for example, a server) according to Transport Protocol Expert Group (TPEG) standard so as to be sent to a broadcasting station. Accordingly, the broadcasting station inserts such traffic information including the traffic light information in a broadcast signal and broadcasts the broadcast signal to the telematics terminal 200. Here, the traffic light information may alternatively be received from a server installed in a traffic light when a vehicle approaches the corresponding traffic light.

The server may reconstruct various traffic information, which are collected via different paths connected to the communication network, for example, collected by an operator's input, via a wired/wireless Internet and digital broadcast services, such as Transport Data Channel (TDC) and Multimedia Object Transport (MOC), or from other servers or a probe car, into a traffic information format, such as a format according to the TPEG standard, which is a standard for traffic information services, thereby sending the reconstructed traffic information to the broadcasting station.

The server may thus generate the traffic information format of the TPEG standard including traffic light information to send to the broadcasting station.

The broadcasting station may then load the traffic information including the traffic light information received from the server in a broadcast signal and wirelessly send the broadcast signal to the telematics terminal 200, for example, a navigation apparatus, which is mounted in the vehicle to play a role of a traffic information receiving terminal. The traffic information may include not only the traffic light information but also information related to various traffic conditions, which are required for running vehicles, ships and flights, such as accidents, road conditions, traffic jam, road construction, road block, public traffic network delay, flight delay and the like.

The broadcasting station may receive the traffic information including the traffic light information processed by the server, and send the same to the telematics terminal 200 via a digital signal according to various digital broadcasting standards, examples of which may include European Digital Audio Broadcasting (DAB) based on Eureka-147(ETSI EN 300 401), Digital Multimedia Broadcasting-terrestrial/satellite (DMB-T/S), Digital Video Broadcasting-terrestrial (DVB-T), portable Digital Video Broadcasting-Handheld (DVB-H), Media Forward Link Only (MFLO) and the like.

Also, the broadcasting station may send the traffic information including the traffic light information via a wired/wireless network, such as a wired/wireless Internet.

The vehicle having the telematics terminal 200 indicates any transport of a typical car, bus, train, ship, flight and the like, which are made by employing mechanical and electronic devices for the purpose of carrying or transporting humans or objects.

The vehicle has a traffic information receiving terminal to receive traffic light information from the broadcasting station. The traffic light information is processed to be sent to a user in a graphic, text and/or audio format(s).

The telematics terminal 200 may include a mobile communication module. The mobile communication module may send and receive wireless signals to/from at least one of a base station 10, an external terminal and a server over a mobile communication network. Here, the wireless signals may include a voice call signal, a telephony call signal and/or various types of data in response to transmission/reception of text/multimedia messages.

The telematics terminal 200 may communicate with a vehicle terminal 100 using a wired/wireless communication technology. The vehicle terminal 100 may perform a typical vehicle control, provide vehicle related information such as speed, gear state and the like, turn an emergency light of the vehicle on/off, turn a headlight on/off, determine whether or not a passenger has taken a seat by a sensor installed within a seat in the vehicle, blow a horn and the like. The vehicle terminal 100 may include a HUD or projector.

FIG. 1C is a block diagram illustrating a configuration of a telematics terminal 200 according to an exemplary embodiment disclosed in this specification.

As shown in FIG. 1C, the telematics terminal 200 may include a main board 210. The main board 210 may include a controller (for example, a central processing unit (CPU)) 212 for overall control of the telematics terminal 200, a memory 213 for storing various types of information, a key controller 211 for control of various types of key signals, and a liquid crystal display (LCD) controller 214 for control of LCD.

The memory 213 may store map information (map data) for displaying road guidance information on a digital map. Also, the memory 213 may store a traffic information collection control algorithm for allowing input of traffic information according to road conditions that a vehicle is currently traveling, and information for control of the algorithm.

The main board 210 may include a wireless communication module 206 for performing wireless communications between the telematics terminal 200 and a wireless communication system or between the telematics terminal 200 and a network in which the telematics terminal 200 is present, a location information module 207 for receiving a Global Positioning System (GPS) signal to guide a location of a vehicle, track a traveling route from a depart point to an arrival point, etc., or transmitting traffic information collected by a user using a GPS signal, a compact disk (CD) deck 208 for reproducing a signal recorded on a CD, a gyro sensor 209, and the like. The wireless communication module 206 and the location information module 207 may transmit and receive signals via corresponding antennas 204 and 205, respectively.

The wireless communication module 206 may include a mobile communication module 206a as a mobile communication terminal having a uniquely given device number for transmitting and receiving wireless signals with at least one of a base station, an external terminal and a sever over a mobile communication network, a wireless Internet module 206b for allowing wireless Internet access by technologies, such as Wireless LAN (WLAN), Wi-Fi, Wireless broadband (Wibro), World Interoperability for Microwave Access (Wimax), High Speed Downlink Package Access (HSDPA) and the like, and a short-range communication module 206c for performing communications by technologies, such as Bluetooth, Radio Frequency IDentification (RFID), Infrared Data Association (IrDA), Ultra WideBand (UWB), ZigBee, Wireless LAN (protocols such as Bluetooth, 802.11n, etc.) and the like.

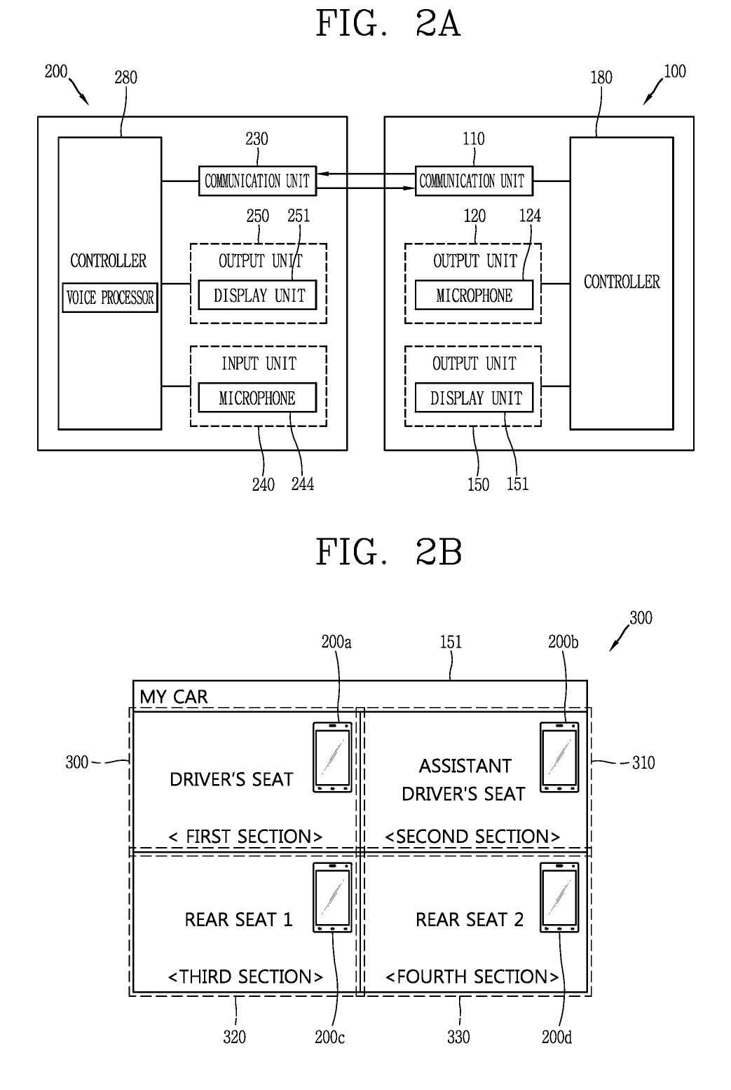

The broadcast receiving module 222 may be connected to the main board 210 to receive a broadcast signal via an antenna 223. The main body 210 may be connected, via an interface board 203, with a display (LCD) 201 controlled by the LCD controller 214, a front board 202 controlled by the key controller 211, and a camera 227 for capturing inside and/or outside of the vehicle. The display 201 may display various video signals, text signals and the like. The front board 202 may be provided with buttons for various types of key signal inputs, and provide a key signal corresponding to the user-selected button to the main board 210. Also, the display 201 may include the proximity sensor and the touch sensor (touch screen) shown in FIG. 2.

The front board 202 may include a menu key for allowing direct input of traffic information. The menu key may be controlled by the key controller 211.

The audio board 217 may be connected to the main board 210 to process various audio signals. The audio board 217 may include a microcomputer 219 for control of the audio board 217, a tuner 218 for receiving a radio signal, a power supply unit 216 for supplying power to the microcomputer 219, and a signal processor 215 for processing various audio signals.

The audio board 217 may also include a radio antenna 220 for receiving a radio signal, and a tape deck 221 for reproducing an audio tape. The audio board 217 may further include an audio output unit (for example, amplifier) 226 for outputting an audio (voice) signal processed in the audio board 217.

The audio output unit (amplifier) 226 may be connected to a vehicle interface 224. That is, the audio board 217 and the main board 210 may be connected to the vehicle interface 224. The vehicle interface 224 may also be provided for connection of a hands-free 225a for inputting a voice signal, an airbag 226b for safety of a passenger, a speed (velocity) sensor 225c for detecting the vehicle speed, and the like. The speed sensor 225c may calculate the vehicle speed and provide the calculated speed information to the controller (CPU) 212.

A navigation session 300 applied to the telematics terminal 200 may generate road guidance information based upon map data and current location information related to the vehicle, and notify a user of the generated road guidance information.

The display 201 may detect a proximity touch within a display window via a proximity sensor. For example, the display 201 detects a location of a proximity touch when a pointer (for example, a finger or a stylus pen) generates the proximity touch, and outputs location information corresponding to the detected location to the controller 212.

A voice recognition device (or voice recognition module) 301 may recognize a user's voice, and perform a corresponding function according to the recognized voice signal.

The navigation session 301 applied to the telematics terminal 200 may display a travel path on map data. The foregoing description has been given of the embodiments in which the telematics terminal 200 is a mobile terminal, but the present invention is not limited to this. The present invention may be applied to every terminal which can perform communication with a driver assistance apparatus.

Components of a vehicle driving assist have been described above. Below is a description of the relationship between a vehicle driving assist according to the present invention and a mobile terminal. FIGS. 2A and 2B are conceptual diagrams illustrating the relationship between a vehicle driving assist according to the present invention and a mobile terminal.

A vehicle driving assist 100 according to the present invention may include at least one of the components described in FIG. 1. More specifically, as depicted in FIG. 2A, the vehicle driving assist 100 may include a communication unit 110, an input unit 120, an output unit 150, and a controller 180. Although not shown, the vehicle driving assist 100 may further include a position information unit (not shown) for locating the position of a mobile terminal in the vehicle.

The communication unit 110 may communicate with an electronic device capable of communication in or adjacent to the vehicle, either wired or wirelessly. For example, the communication unit 110 may communicate either wired or wirelessly for data exchange between the vehicle driving assist and the vehicle, between the vehicle driving assist and a mobile terminal in the vehicle, or between the vehicle driving assist and an external server.

The input unit 120 may be configured to receive a control command from a user. For example, the input unit may include a microphone 124 that receives an utterance from a user in the vehicle.

The output unit 150 may include a display unit 151 to visually output information related to functions executed by the vehicle driving assist. The display unit 151 may include an HUD (head up display), a display with a built-in cluster, etc.

The controller 180 may control the communication unit 110, input unit 120, and output unit 150, to take control of the vehicle. For example, the controller 180 may display on the display unit 151 a notification of receipt of a control command from a specific mobile terminal in the vehicle. In another example, the controller 180 may display on the display unit 151 a result of air conditioner control in the vehicle via a control command received through the input unit.

The position information unit may be configured to send out a particular signal to the inside of the vehicle and receive a response signal to the sent signal, in order to locate the position of a mobile terminal in the vehicle. For example, the position information unit may locate the position of mobile terminal in the vehicle by sending out a beacon signal and receiving a response signal to the sent beacon signal.

Also, a mobile terminal 200 communicating with the vehicle driving assist may include a communication unit 230, an output unit 250, an input unit 240, and a controller 280. The controller 280 of the mobile terminal 200 may further include a voice processor. The voice processor may process voice data corresponding to a voice input from outside the mobile terminal through a preset voice recognition algorithm. As such, the voice processor may generate a vehicle control command for controlling the vehicle, based on the processed voice data. These components of the mobile terminal may perform the same or similar functions to the aforementioned components of an electronic device in a vehicle. Thus, a description of them will be substituted with the foregoing description.

Meanwhile, the vehicle driving assist may divide the inside of the vehicle 300 into a plurality of virtual sections. For example, as depicted in FIG. 2B, the inside of the vehicle may include a first section 300 including a driver's seat in the front of the vehicle, a second section 310 including an assistant driver's seat in the front of the vehicle, a third section 320 including a seat behind the driver's seat, and a fourth section 330 including a seat behind the assistant driver's seat.

Also, although not shown, the inside of the vehicle may be divided into a varying number of virtual sections of various shapes, as selected by a user, or depending on the type, structure, etc. of the vehicle. Although the following description will be given of the inside of the vehicle divided into four sections, the present invention may also apply to the inside of the vehicle divided into a different number of sections.

Moreover, the vehicle driving assist may give each of the plurality of virtual sections a different level of control authority. Here, the term control authority may mean the authority to take control of the vehicle.

That is, the vehicle driving assist may determine whether to perform vehicle control or not, depending on which of the plurality of virtual sections a user giving a vehicle control command input is positioned in. For example, if a control command for air purification within the vehicle is input from the user in the first section 300, the vehicle driving assist may control the vehicle to execute a vehicle air purification function. On the contrary, if a control command for air purification within the vehicle is input from the user in the third section 320, the vehicle driving assist may control the vehicle to not execute the vehicle air purification function.

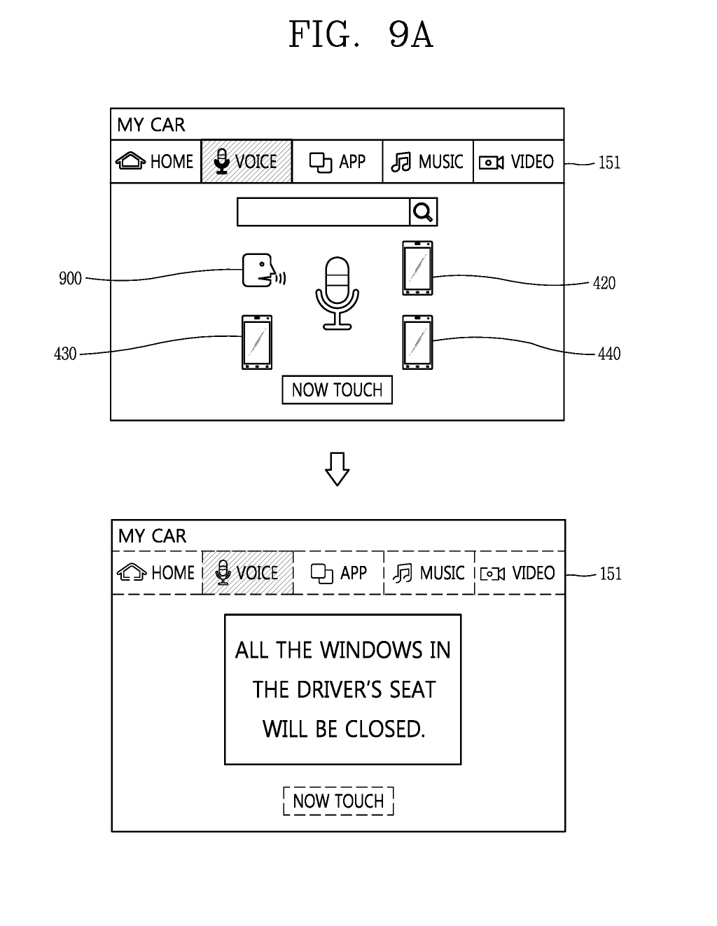

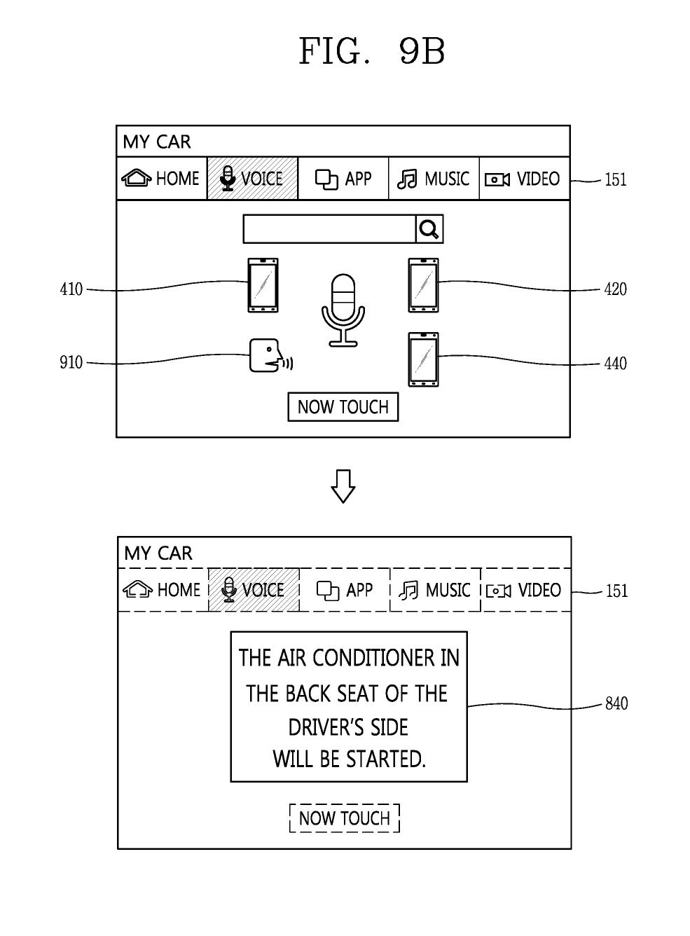

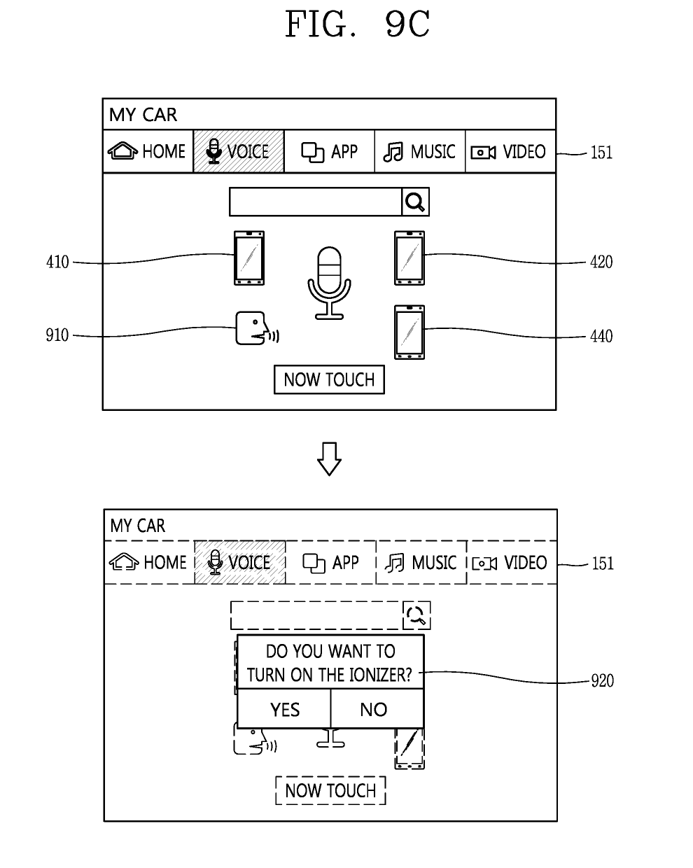

Alternatively, based on the position of an utterance for generating a vehicle control command, the controller 180 of the vehicle driving assist may process the vehicle control command in connection with the position of the utterance. More specifically, the controller 180 may detect a particular section including the position of the utterance, among the plurality of virtual sections and process a vehicle control command corresponding to the utterance with respect to the particular section. For example, if the position of an utterance “Turn on the air conditioner” corresponds to the first section including the driver's seat, the controller 180 may run the air conditioner in the first section. A more detailed description will be given with reference to FIGS. 9A to 9C.

To this end, the controller 180 of the vehicle driving assist may determine which of the plurality of virtual sections an input is received from, based on the positions of a plurality of mobile terminals in the vehicle or the position of the input unit 120 equipped in the vehicle.

For example, as depicted in FIG. 2B, the controller 180 may identify which of the plurality of virtual sections a plurality of mobile terminals 200A, 200B, 200C, and 200D in the vehicle are positioned. Accordingly, the controller 180 may identify a virtual section from which a control command is input, based on the position of the mobile terminal that has issued the control command, among the plurality of mobile terminals.

In another example, the controller 180 of the vehicle driving assist may identify which of the plurality of virtual sections an input is received from, through the input part 120 in the vehicle. For example, if the input unit 120 equipped in the vehicle is in the first section 300, the controller 180 may recognize a control command input through the input unit 120 as a control command generated in the first section 300.

Hereinafter, a method for controlling a vehicle via voice in a vehicle driving assist including at least one of the aforementioned components will be described.

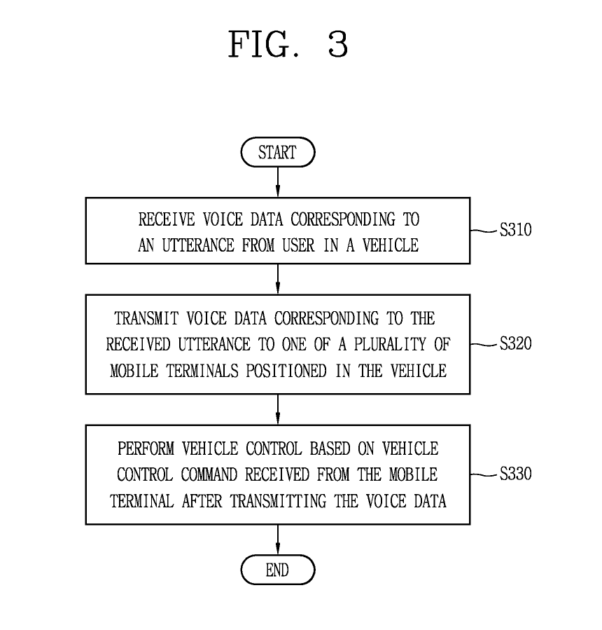

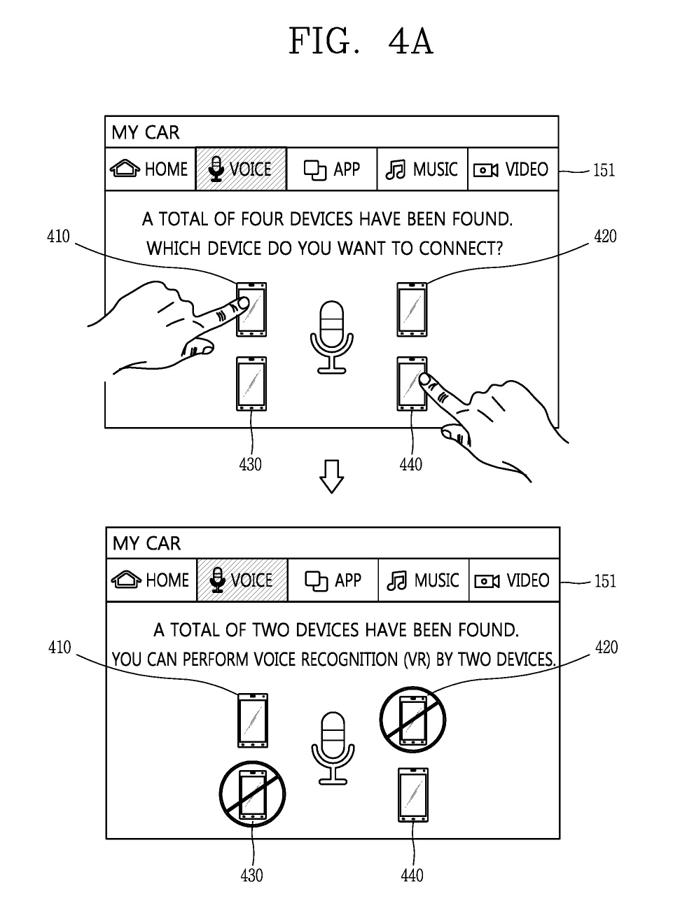

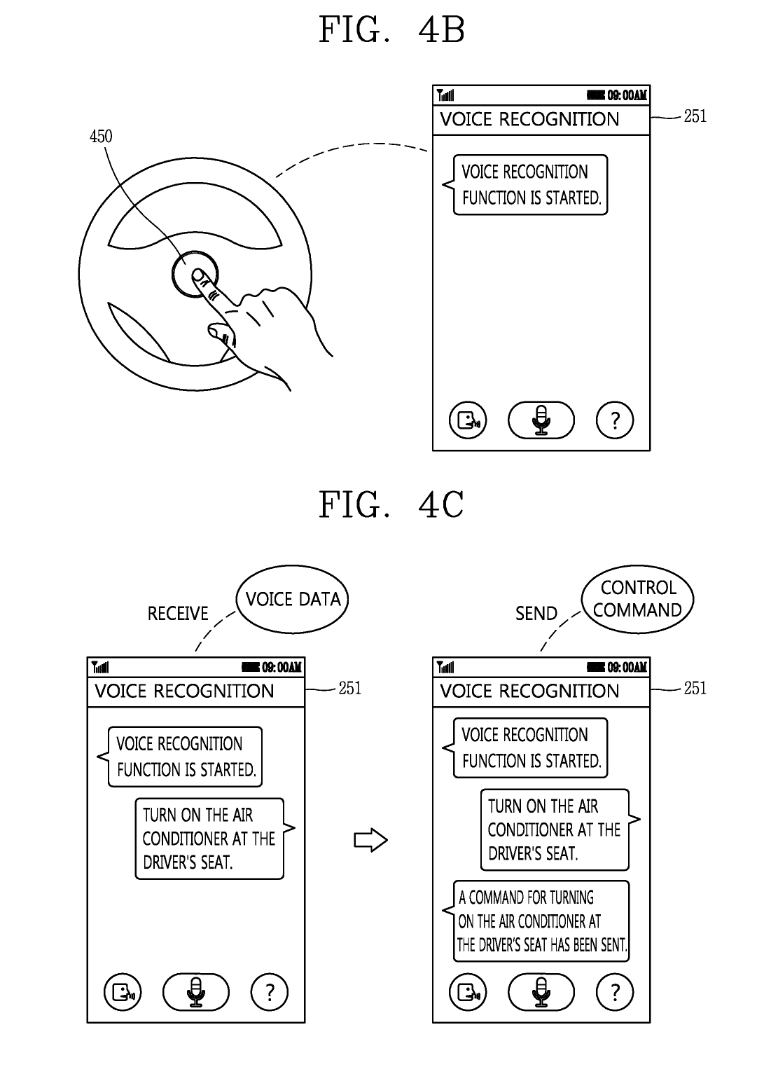

FIG. 3 is a flowchart of a method for controlling a vehicle via voice in a vehicle driving assist that assists the vehicle's driving. FIGS. 4A, 4B, and 4C are conceptual diagrams showing the control method of FIG. 3.

First of all, a vehicle driving assist according to the present invention may receive voice data corresponding to an utterance from a user in the vehicle (S310).

At least one user may be positioned in the vehicle. In this case, the controller 180 of the vehicle driving assist may receive voice data corresponding to at least one utterance from at least one user in the vehicle.

The microphone 124 in the vehicle driving assist that receives the voice data or the microphone of the mobile terminal positioned in the vehicle may be activated to receive an utterance from a user, based on a request from the user. For example, as depicted in FIG. 4B, the user may enter a control command for voice input via a button 450 on a steering wheel in the vehicle. In this case, the controller 180 may activate the microphone 124 in the vehicle driving assist or the microphone on a mobile terminal capable of communicating with the vehicle, in response to the control command for voice input. In another example, the user may enter a control command for voice input into the mobile phone they are carrying. In this case, the mobile terminal may activate the microphone 124 in the vehicle driving assist or the microphone on the mobile terminal, in order to receive voice input from the user.

The at least one user may enter their voice through the microphone 124 in the vehicle driving assist or the microphone on the mobile terminal in the vehicle. For example, the user in the driver's seat may enter voice data corresponding to an utterance through the microphone 124 positioned adjacent to the driver's seat. In another example, the user in the assistant driver's seat may enter voice data corresponding to an utterance through the microphone on their mobile terminal.

Moreover, a specific user among the at least one user may restrict voice input from other users other than itself. For example, the driver may restrict voice input for vehicle control from the user in the assistant driver's seat.

Alternatively, the driver may enter a control command for controlling the microphone to receive an utterance from the user in the assistant driver's seat, by using a graphical object associated with a function for controlling the microphone displayed on the display unit. In this case, the controller 180 may control the microphone to receive an utterance from the assistant driver's seat.

Upon receiving the voice data, the vehicle driving assist may transmit the received voice data corresponding to the utterance to one of the plurality of mobile terminals in the vehicle (S320).

The controller 180 of the vehicle driving assist may transmit the received voice data corresponding to the utterance to one of the plurality of mobile terminals in the vehicle to process the received voice data.

The plurality of mobile terminals in the vehicle may be mobile terminals capable of communicating with the vehicle either wired or wirelessly. A mobile terminal capable of communicating with the vehicle either wired or wirelessly may be viewed as having the same meaning as a mobile terminal interoperating with the vehicle. For example, the plurality of mobile terminals may interoperate with the vehicle driving assist via Bluetooth communication.

Meanwhile, the vehicle driving assist may interoperate with all of the plurality of mobile terminals in the vehicle or interoperate with only some of the plurality of mobile terminals, as selected by the user. In this case, some mobile terminals to interoperate with the vehicle may be selected by the user. For example, as depicted in the first image of FIG. 4A, the controller 180 may detect four mobile terminals in the vehicle. Also, the controller 180 may display graphical objects 410, 420, 430, and 440 representing the four detected mobile terminals.

The user may select the graphical objects 410 and 440 representing two mobile terminals to interoperate with the vehicle, from among the graphical objects 410, 420, 430, and 440 representing the four mobile terminals. In this case, the controller 180 may interoperate with the two selected mobile terminals. Also, as depicted in the second image of FIG. 4A, the controller 180 may display the graphical objects 420 and 430 representing the other two mobile terminals not selected in such a way as to be visually distinctive from the graphical objects 410 and 440 representing the two selected mobile terminals.

Although the following description will be given on the assumption that all of the plurality of mobile terminals in the vehicle interoperate with the vehicle driving assist, the present invention may also apply in the same or similar manner to when some mobile terminals in the vehicle and the vehicle driving assist interoperate together.

Moreover, the plurality of mobile terminals interoperating with the vehicle driving assist may be configured to process voice data through different voice recognition algorithms. Here, the term voice recognition refers to a process of identifying and extracting the linguistic meaning of voice data. More specifically, voice recognition involves identifying the linguistic meaning of voice data and translating it into text based on a preset database.

For example, a first terminal among the plurality of mobile terminals may process voice data through a first voice recognition algorithm, and a second terminal among the plurality of mobile terminals may process voice data through a second voice recognition algorithm. That is, the vehicle driving assist according to the present invention may process voice data through one of a plurality of voice recognition algorithms.

A mobile terminal for processing voice data may be set as default or determined as selected by the user or according to a preset condition. Here, the preset condition may be a condition relating to at least one among the mobile terminal's resources, the mobile terminal's position, and the mobile terminal's voice recognition engine type. The resources collectively refer to the mobile terminal's resources relating to data processing—for example, the degree of common memory access competition. In this case, the use of a small amount of resources may be construed that the amount of memory currently being used is small, and the use of a large amount of resources may be construed that the amount of memory currently being used is large.

The voice recognition engine type is information about the provider of a voice recognition algorithm—for example, Google, Naver, Daum, Nexus, etc. which provides voice recognition algorithms.

For example, the controller 180 may set the mobile terminal in the section closest to a user who has made an utterance as a default mobile terminal. In this case, upon receiving voice data corresponding to the user's utterance, the controller 180 may transmit the voice data to the mobile terminal in the section closest to the user.

In another example, the controller 180 may display on the display unit 151 a plurality of graphical objects for the plurality of mobile terminals. In this case, the user may select a mobile terminal representing one of the plurality of graphical objects by touching that graphical object.

In another example, the controller 180 may receive each mobile terminal's resource information from the plurality of mobile terminals and select a mobile terminal that uses the smallest amount of resources based on the resource information.

The mobile terminal that has received the voice data may process the voice data through a voice recognition algorithm set up on the mobile terminal.

The voice recognition algorithm refers to an algorithm that electronically processes an utterance from a human to text data. For example, the voice recognition algorithm includes Hidden Markov Model (HMM), which is an algorithm in which utterances from different speakers are statistically modeled to create a linguistic model.

Further, the voice recognition algorithm may include a natural language processing algorithm (NLP). The natural language processing algorithm is an algorithm in which natural language spoken by humans is mechanically analyzed and processed by a computer.

The mobile terminal that has received the voice data may process the voice data through a voice recognition algorithm and generate a vehicle control command for controlling the vehicle based on the processed voice data.

When the mobile terminal is selected, the controller 180 may display a graphical object representing this mobile terminal displayed on the display unit 151 in such a way as to be visually distinctive from the other graphical objects. That is, for processing current voice data, the vehicle driving assist of this invention may visually identify a mobile terminal with a voice recognition algorithm running on it from other mobile terminals so that the user may perceive this mobile terminal. Also, a plurality of users in the vehicle may perceive the user who is currently performing voice recognition.

While the foregoing description has been made with respect to a plurality of mobile terminals positioned in a vehicle, voice data may be transmitted to a single mobile terminal if this mobile terminal processes voice data through a plurality of different voice recognition algorithms. In this case, the mobile terminal may process voice data through one of the plurality of different voice recognition algorithms as selected by the user or according to a preset condition.

That is, the vehicle driving assist according to the present invention may process voice data through various voice recognition algorithms that are set up on a plurality of mobile terminals interoperating with the vehicle.

After transmitting the voice data, the vehicle driving assist may perform vehicle control based on a vehicle control command received from one of the plurality of mobile terminals (S330).

For processing voice data, the controller 180 of the vehicle driving assist may transmit the voice data to one of the plurality of mobile terminals and then receive a vehicle control command from this mobile terminal.

The vehicle control command may include a control command for assisting the vehicle's driving, a control command for controlling vehicle components, etc. Examples of the vehicle control command may include an air conditioner on/off control command, a vehicle speaker volume control command, a voice reception on/off control command, a control command related to air purification, and a control command for vehicle temperature control.

That is, the controller 180 may receive a generated vehicle control command based on voice data corresponding to an utterance received from a user. Also, the controller 180 may perform vehicle control based on the vehicle control command. For example, as depicted in the first image of FIG. 4C, upon receiving voice data “Turn on the air conditioner at the driver's seat.”, the controller 180 may transmit the voice data to one of the mobile terminals.

The mobile terminal that has received the voice data may generate a control command related to “driver seat air conditioner operation” based on the voice data “Turn on the air conditioner at the driver's seat.” Afterwards, this mobile terminal may transmit the generated control command related to “driver seat air conditioner operation” to the vehicle driving assist. Also, as depicted in the second image of FIG. 4C, the mobile terminal may display on the display unit 151 of the mobile terminal a notification indicating that the control command related to “driver seat air conditioner operation” has been sent.

In this case, the controller 180 of the vehicle driving assist may start the air conditioner at the driver's seat, based on the control command related to driver seat air conditioner operation.

Meanwhile, the controller 180 may process the vehicle control command in connection with a particular section including the position of the utterance, based on the position of the utterance corresponding to the voice data. For example, if the position of the utterance corresponding to the voice data is in the first section including the driver's seat, the controller 180 may control the vehicle components in the first section, based on the vehicle control command. In this case, the controller 180 may not control the vehicle components in the second, third, and fourth sections.

Moreover, if the vehicle control command corresponding to the voice data is a control command for a section other than the particular section including the position of the utterance corresponding to the voice data, the controller 180 may display on the display unit 151 a pop-up window asking whether to perform vehicle control or not. That is, the controller 180 may allow the driver to choose whether to perform control or not in response to the vehicle control command corresponding to the voice data. As such, to ensure driving safety, the present invention may restrict other users other than the user in the driver's seat from having overall control of the vehicle.

Meanwhile, for an utterance made in the first section including the driver's seat, unlike for utterances made in the other sections (the second, third, and fourth sections), the controller 180 may perform control of the other sections too, based on a control command corresponding to the utterance made in the first section. That is, the driver may take overall control of the vehicle by having the overall authority to control the vehicle.

After performing vehicle control based on the vehicle control command, the controller 180 may display vehicle control result information on the display unit 151. Also, the controller 180 may determine the level of disclosure of the result information, depending on whether the result information is privacy information. For example, if the result information is privacy information, the controller 180 may display only brief information of the result information or not display the result information at all. Accordingly, the present invention may protect the privacy of the plurality of users in the vehicle.

A method for processing an utterance made in a vehicle via a mobile terminal in the vehicle and controlling the vehicle via a control command based on voice data processed by the mobile terminal has been described above.

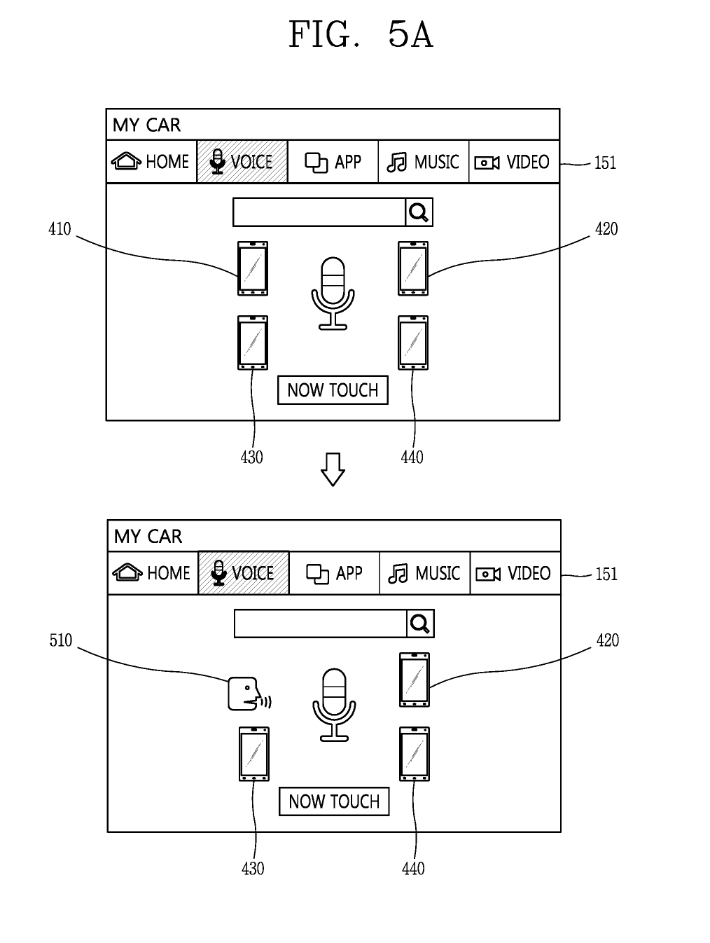

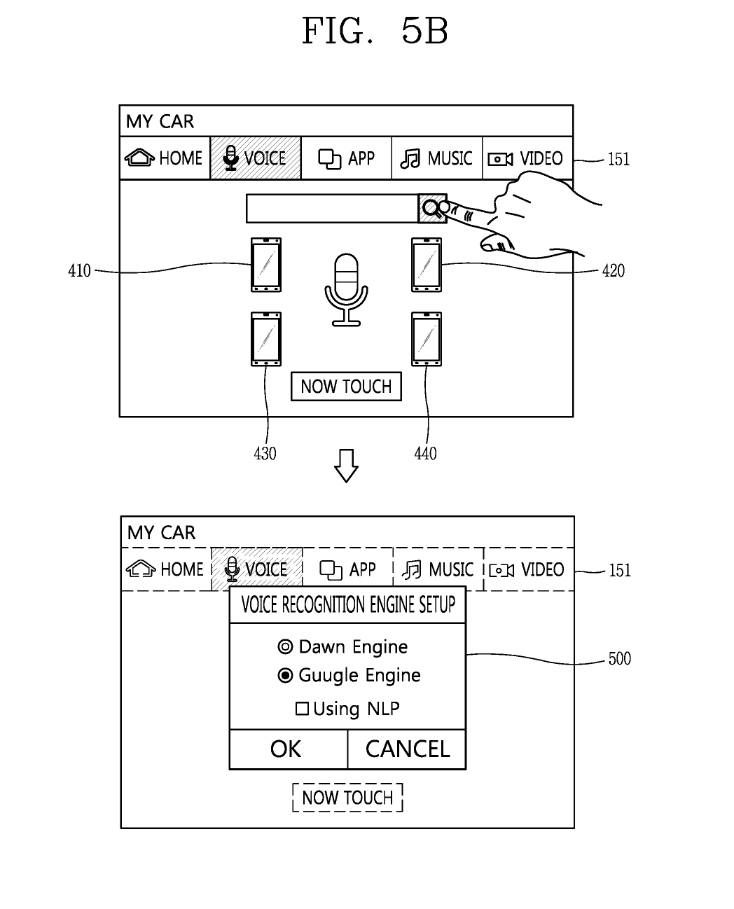

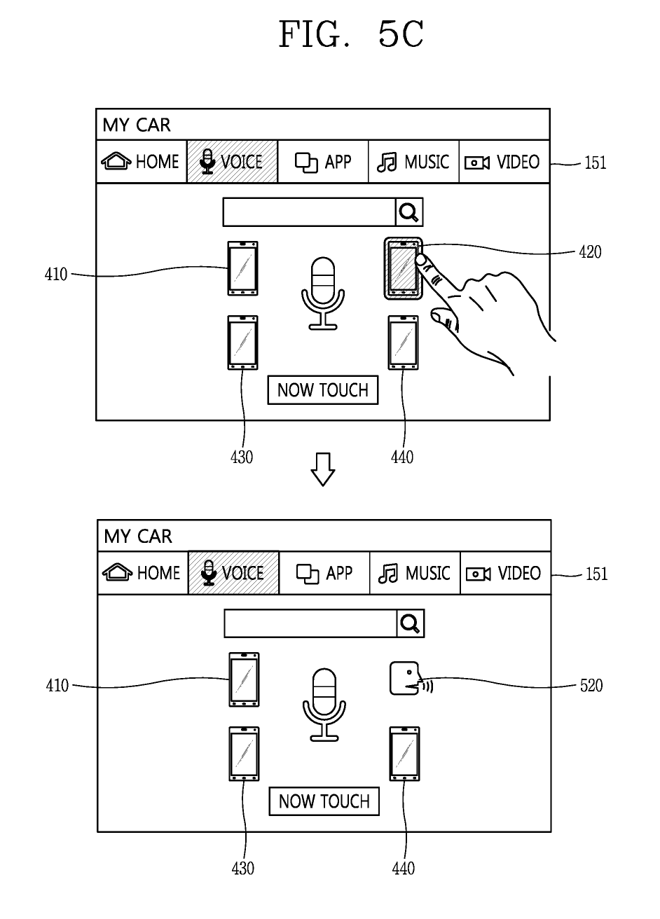

Below is a description of a method for determining a mobile terminal for processing voice data corresponding an utterance from a user, among a plurality of mobile terminals positioned in a vehicle, will be described. FIGS. 5A, 5B, and 5C are conceptual diagrams showing a control method for determining a mobile terminal for processing voice data corresponding to an utterance from a user, among a plurality of mobile terminals positioned in a vehicle.

The controller 180 may determine a mobile terminal for performing a voice recognition function, among a plurality of mobile terminals positioned in a vehicle. More specifically, the controller 180 may determine a default mobile terminal as a mobile terminal for performing the voice recognition function. Alternatively, the controller 180 may select one of a plurality of mobile terminals positioned in a vehicle, according to a preset condition. Alternatively, the controller 180 may select one of a plurality of mobile terminals positioned in a vehicle, as selected by the user.

For example, as depicted in the first image of FIG. 5A, the controller may determine a default mobile terminal positioned in the driver's seat as a mobile terminal for performing the voice recognition function. The default mobile terminal may be a mobile terminal with its identity information stored in it. For example, the mobile terminal with its identity information stored in it may be a mobile terminal with a history of interoperation with the vehicle driving assist.

Once a mobile terminal for performing the voice recognition function is determined, the controller 180 may display on the display unit 151 a graphical object representing the mobile terminal for performing the voice recognition function in such a way as to be visually distinctive from the graphical objects representing the other mobile terminals not selected, as depicted in the second image of FIG. 5A.

Moreover, the controller 180 may select one of the plurality of mobile terminals positioned in the vehicle, according to a preset condition. For example, the controller 180 may determine the mobile terminal in the section closest to a user who has made an utterance, among the plurality of mobile terminals, as a mobile terminal for performing the voice recognition function. In another example, the controller 180 may determine the mobile terminal using the least amount of resources among the plurality of mobile terminals, as a mobile terminal for performing the voice recognition function.

In another example, the controller 180 may determine a mobile terminal using a specific voice recognition engine selected by the user, among the plurality of mobile terminals, as a mobile terminal for performing the voice recognition function. More specifically, as depicted in FIG. 5B, the controller 180 may display a voice recognition engine list 500 containing a category about a plurality of voice recognition engines, based on a user request. Here, the plurality of voice recognition engines may be voice recognition engines that are set up on a plurality of mobile terminals interoperating with the vehicle driving assist. In this case, once one of the plurality of voice recognition engines is selected based on a user request, the controller 180 may determine a mobile terminal corresponding to the selected engine as a mobile terminal for performing the voice recognition function.

Although not shown, the controller 180 may display on the display unit 151 a graphical object representing the mobile terminal for performing the voice recognition function in such a way as to be visually distinctive from the graphical objects representing the other mobile terminals not selected.

Moreover, the controller 180 may set a mobile terminal for performing the voice recognition function, as selected by the user. For example, as depicted in the first image of FIG. 5C, the controller 180 may display on the display unit 151 a plurality of graphical objects 410, 420, 430, and 440 respectively representing a plurality of mobile terminals. In this case, the controller 180 may set one of the plurality of graphical objects 410, 420, 430, and 440 corresponding to the graphical object 420 touched by the user as a mobile terminal for performing the voice recognition function.

As depicted in the second image of FIG. 5C, once a mobile terminal for performing the voice recognition function is selected, the controller 180 may display the graphical object 420 representing this mobile terminal in such a way as to be visually distinctive from the other graphical objects 410, 430, and 440.

When a specific mobile terminal for performing the voice recognition function is determined in the above-explained way, the controller 180 may execute the voice recognition function through the specific mobile terminal.

The method for determining a specific mobile terminal for performing the voice recognition function, among a plurality of mobile terminals positioned in a vehicle, has been described above. With this method, the present invention allows for data processing through various voice recognition engines by performing the voice recognition function through a plurality of mobile terminals positioned in a vehicle.

Moreover, the present invention may perform voice recognition through a mobile terminal besides the mobile terminal of a user's who makes an utterance. As such, the present invention may perform voice recognition through a voice recognition algorithm besides the voice recognition algorithm set up on a user's own mobile terminal.

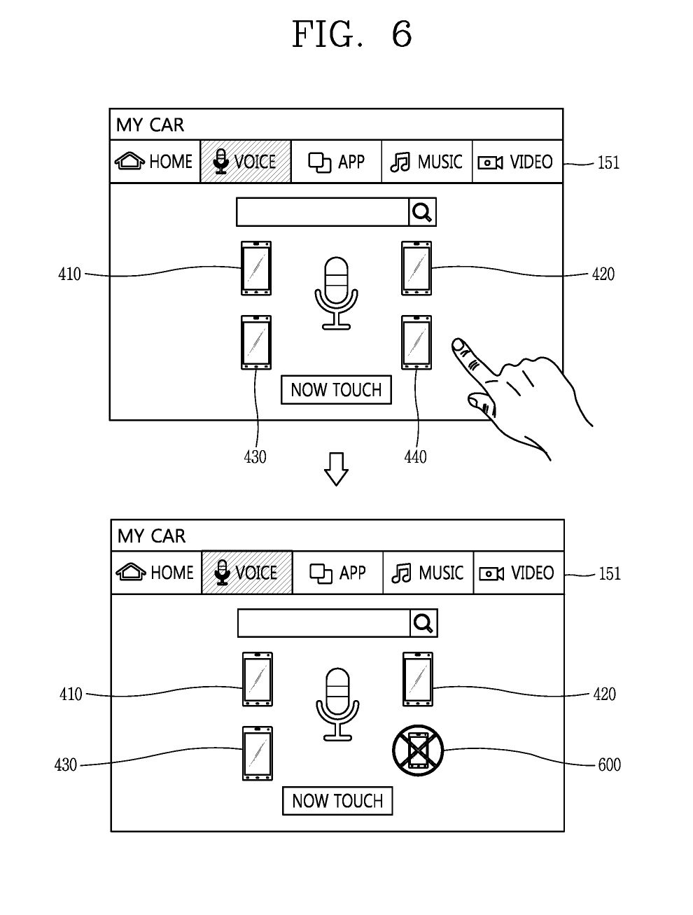

A method for controlling a voice recognition function on a plurality of mobile terminals positioned in a vehicle will be described below. FIG. 6 is a conceptual diagram showing a method for restricting a voice recognition function on a plurality of mobile terminals positioned in a vehicle.

The controller 180 may control the execution of a voice recognition function on a plurality of mobile terminals positioned in a vehicle. More specifically, the controller 180 may determine one of a plurality of mobile terminals as a mobile terminal for executing the voice recognition function.

Meanwhile, the controller 180 may determine a mobile terminal for restricting a specific one of the plurality of mobile terminals from executing the voice recognition function. That is, the present invention may restrict the execution of the voice recognition function through a specific one of the plurality of mobile terminals in the vehicle.

For example, as depicted in the first image of FIG. 6, the controller 180 may sense a present type of touch applied on the graphical object 440 representing a specific mobile terminal, among the plurality of graphical objects 410, 420, 430, and 440 representing the plurality of mobile terminals. Here, the preset type of touch may be a double touch, a long touch, etc.

The controller 180 may disable the interoperation between the specific mobile terminal and the vehicle driving assist so as to keep the specific mobile terminal corresponding to the touched graphical object 440 from processing voice data. Once the interconnection is disabled, the specific mobile terminal is not able to receive voice data from the vehicle driving assist. In this case, as depicted in the second image of FIG. 6, if the specific mobile terminal is configured to not process voice data, the controller 180 may change the graphical object 440 representing the specific mobile terminal to a graphical object 600 indicating that voice data processing is not available. As such, the present invention may prevent kids in a vehicle from recklessly controlling the vehicle.

Although not shown, if the graphical object 600 indicating that voice data processing is not available is touched, the controller 180 may control the specific mobile terminal corresponding to the graphical object 600 to allow it to process voice data. In this case, on the display unit 151, the graphical object 600 indicating that voice data processing is not available may be changed back to the graphical object 440 representing the specific mobile terminal and indicating that voice data processing is available.

A method for restricting a voice recognition function in a particular section has been described above. With this method, the present invention may prevent reckless vehicle control via voice.

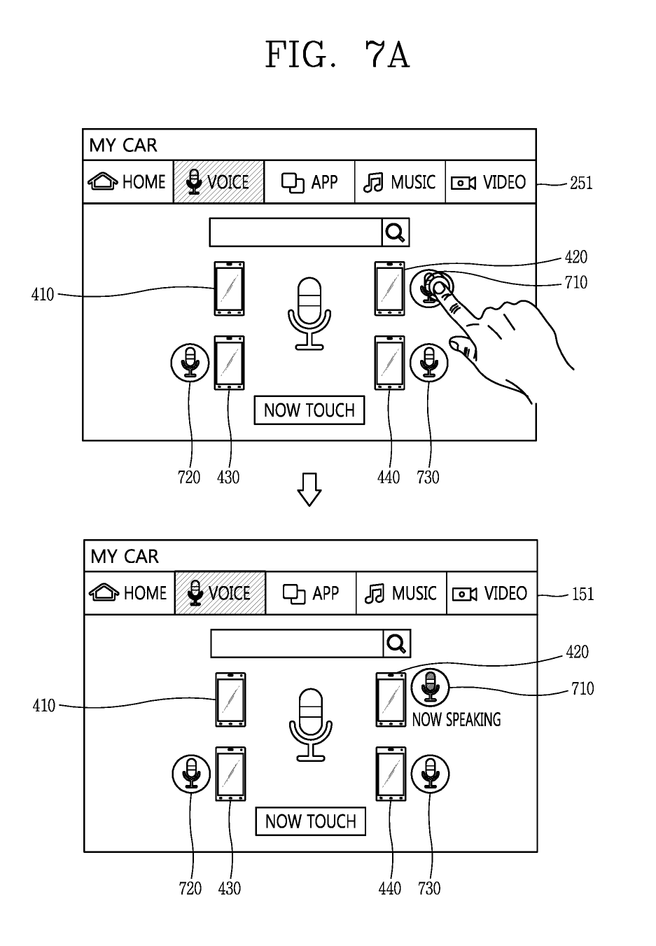

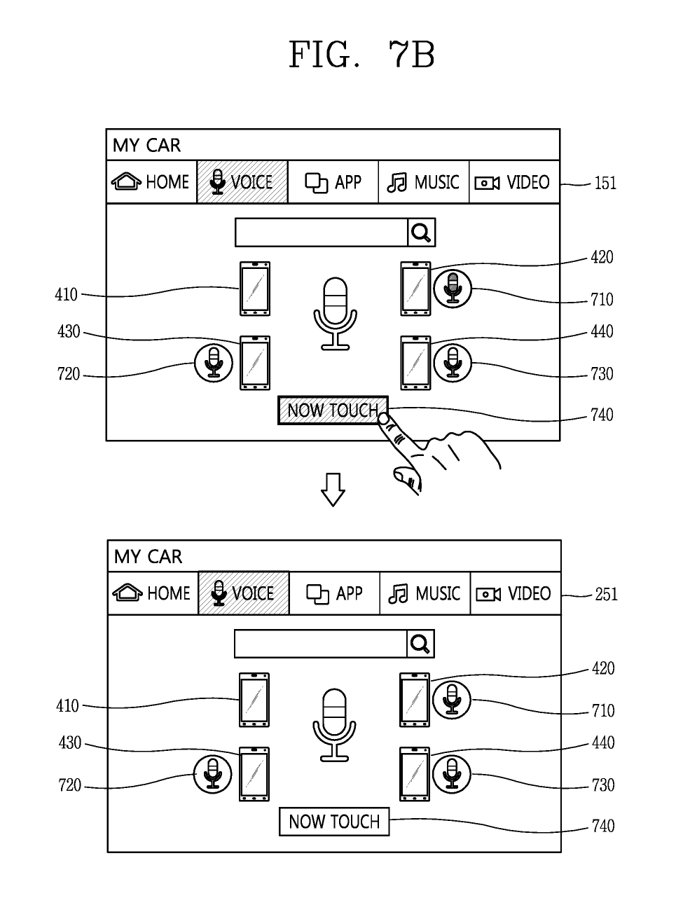

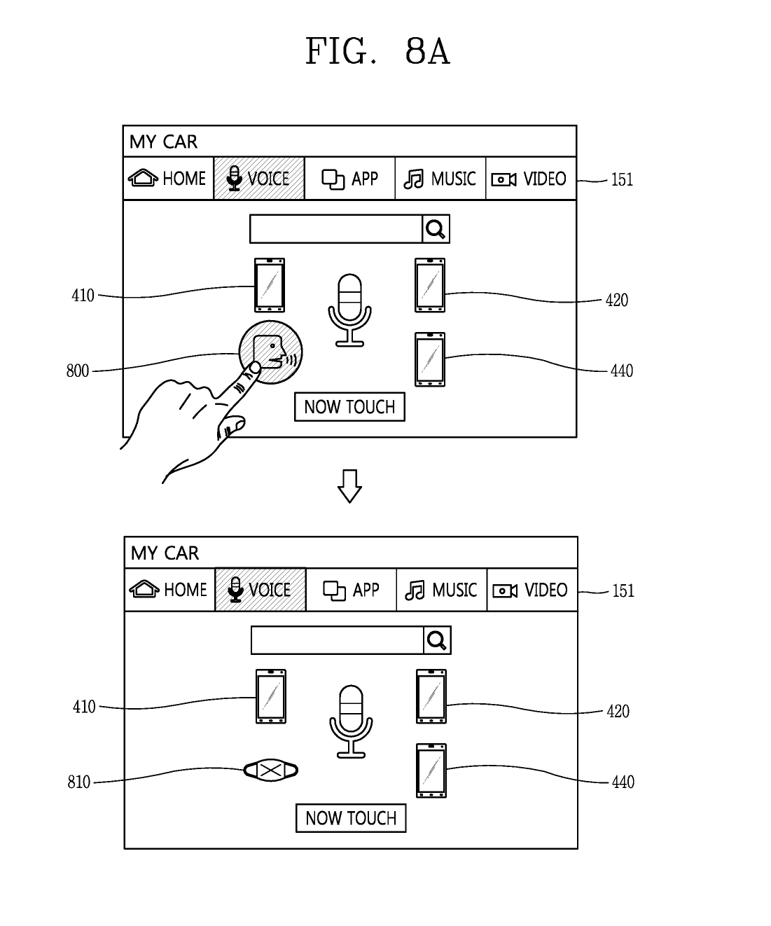

Below is a description of a method for controlling a microphone to receive an utterance from a specific user among a plurality of users in a vehicle. FIGS. 7A and 7B are conceptual diagrams showing a method for controlling a microphone to receive an utterance from a specific user among a plurality of users positioned in a vehicle.

The controller 180 may control the microphone 124 in the vehicle to receive an utterance from a specific one of the plurality of users positioned in the vehicle. More specifically, the microphone 124 in the vehicle driving assist may be set as default to receive the voice of the user in the driver's seat. In this case, as selected by the user, the controller 180 may control the microphone 124 to receive through the microphone 124 an utterance from a user positioned in a particular section other than the driver's seat, among a plurality of virtual sections of the inside of the vehicle.

For example, as depicted in the first image of FIG. 7A, the controller 180 may display graphical objects 710, 720, and 730 associated with a function for activating the microphone in each section, with respect to the other sections other than the section including the driver's seat, among the plurality of virtual sections of the inside of the vehicle. In response to a touch on one 710 of the graphical objects 710, 720, and 730 associated with the function for activating the microphone in each section, the controller 180 may activate the microphone 124 associated with the graphical object 710.

When the microphone 124 in the section associated with the graphical object 710 is activated, the controller 180 may alter the visual appearance of the graphical object 710 to indicate that the microphone is activated. For example, as depicted in the second image of FIG. 7A, when the microphone 124 in the section associated with the graphical object 710 is activated, the controller 180 may display the graphical object 710 in a different color. Accordingly, the user becomes aware that they can currently receive an utterance from a specific one of the plurality of virtual sections of the inside of the vehicle.

Meanwhile, the controller 180 may receive an utterance from the section including the driver's seat even after controlling the microphone 124, so as to receive an utterance from a particular section besides the section including the driver's seat. That is, in the present invention, an utterance from the section including the driver's seat can be received by default all the time, and it is possible to determine whether to receive an utterance from the other sections or not.

While the above description has been given of voice input through the microphone 124 in the vehicle driving assist, the present invention may also process voice input from the microphone of the mobile terminal positioned in each virtual section.

Moreover, after controlling the microphone 124 to receive an utterance from the particular section, the controller 180 may control the microphone 124 to not receive any utterance from the particular section anymore.

More specifically, in a case where the microphone is controlled to receive an utterance from sections other than the one including the driver's seat, the controller 180 may control the microphone to not receive an utterance from sections other than the section including the driver's seat when a control command for deactivating the microphone is issued.

For example, as depicted in the first image of FIG. 7B, while the microphone is being controlled to receive an utterance from a particular section, the controller 180 may sense a touch on a graphical object 740 associated with a control command for deactivating the microphone. In this case, the controller 180 may control the microphone 124 to not receive an utterance from sections other than the section including the driver's seat. Accordingly, the present invention allows for receiving an utterance from the driver's seat all the time.

A method for controlling a microphone in a vehicle has been described above. With this method, the vehicle driving assist may receive an utterance from other different positions other than the driver's seat through a microphone in the vehicle.

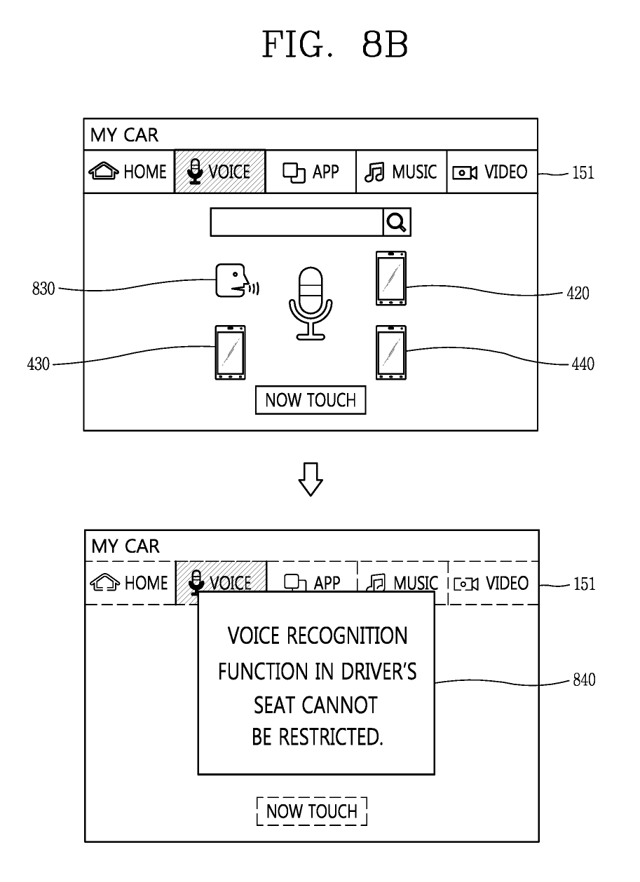

Below is a description of a method for disabling a voice recognition function running on a mobile terminal. FIGS. 8A and 8B are conceptual diagrams showing a method for disabling a voice recognition function running on a mobile terminal.

The controller 180 may disable a voice recognition function based on a user request, while the voice recognition function is running in a particular section. Disabling the voice recognition function may mean ending a voice input being received or ending voice data processing being performed.

For example, as depicted in the first image of FIG. 8A, the controller 180 may display a graphical object 800 representing a mobile terminal positioned in a particular section with a voice recognition function running on it in such a way as to be visually distinctive from the graphical objects 410, 420, and 440 of the mobile terminals with the voice recognition function not running on them.

In this case, in response to a preset type of touch on the graphical object 800 of the mobile terminal with the voice recognition function running on it, the controller 180 may transmit a control command for disabling the voice recognition function to the mobile terminal corresponding to the graphical object 800, in order to disable the voice recognition function. In this case, the mobile terminal corresponding to the graphical object 800 may disable the voice recognition function. Here, the preset type of touch may be a multi-touch, a double touch, a short touch, a long touch, etc.

Moreover, after transmitting a control command for disabling the voice recognition function to the mobile terminal, the controller 180 may change the graphical object 800 to a graphical object 820 indicating that the voice recognition is disabled. Accordingly, the user becomes aware that the voice recognition function through the mobile terminal is disabled.

The mobile terminal with the voice recognition function disabled may end a voice input being received through the mobile terminal or end voice data processing being performed on the mobile terminal. Also, a control command corresponding to voice data to be transmitted from the mobile terminal to the vehicle driving assist may not be transmitted. That is, the present invention may control the mobile terminal with the voice recognition function disabled to not perform vehicle control anymore.

Meanwhile, the controller 180 may restrict the disabling of the voice recognition function of the mobile terminal positioned in the section including the driver's seat. That is, the controller 180 cannot disable the voice recognition function of the mobile terminal positioned in the section including the driver's seat.

For example, as depicted in the first image of FIG. 8B, a graphical object 830 indicating that the voice recognition function is running on the mobile terminal positioned in the section including the driver's seat may be displayed on the display unit 151. The controller 180 may sense a preset type of touch on the graphical object 830 indicating that the voice recognition function is running. In this case, as depicted in the second image of FIG. 8B, the controller 180 may display on the display unit 151 a pop-up window 840 containing a notification “The voice recognition function in the driver's seat cannot be restricted.”. Accordingly, the present invention can achieve driving safety by keeping the voice recognition function in the driver's seat running.

A method for disabling or restricting a voice recognition function running on a mobile terminal positioned in a vehicle has been described above.

Below is a description of a method for controlling a vehicle based on the position of an utterance. FIGS. 9A, 9B, and 9C are conceptual diagrams showing a method for controlling a vehicle based on the position of an utterance.

The controller 180 may receive an utterance from a particular position included in a particular one of a plurality of virtual sections in the vehicle. Also, the controller 180 may perform vehicle control based on a control command corresponding to the utterance.

The controller 180 may process the control command corresponding to the utterance based on the position of the utterance. More specifically, the controller 180 may process the control command corresponding to the utterance in connection with the particular section including the position of the utterance, among the plurality of virtual sections in the vehicle.

For example, the controller 180 may receive an utterance from the first section including the driver's seat. In this case, as depicted in the first image of FIG. 9A, a graphical object 900 indicating that the voice recognition function is being executed in the first section including the driver's seat. In this instance, a graphical object 910 indicating that the utterance from the third section including the back seat of the driver's side may be displayed on the display unit 151.

In this regard, the controller 180 may perform vehicle control based on the control command corresponding to the utterance. For example, as depicted in the second image of FIG. 9A, if the control command corresponding to the utterance is a control command for closing a vehicle window, the controller 180 may perform an operation for closing the vehicle window in the first section.

Moreover, if the position of the utterance is a second position different from a first position, the controller 180 may process the vehicle control command corresponding to the utterance in connection with the second position.

For example, as depicted in the first image of FIG. 9B, the controller may receive an utterance “Turn on the air conditioner” from the third section including the back seat of the driver's side may be displayed on the display unit 151.

In this case, as depicted in the second image of FIG. 9B, upon receiving a control command for starting the air conditioner, the controller 180 may start the air conditioner in the third section. In this case, the controller 180 may not start the air conditioners in the other sections other than the third section. That is, the controller 180 may perform control only on the section including the position of the utterance.

In another example, if the control command corresponding to the utterance from the section including the back seat is a control command for volume control in the back seat, the controller 180 may perform volume control on the back seat. In this case, volume control may not be performed on the front seat.

Meanwhile, if the control command corresponding to the utterance is a control command for controlling a section other than the particular section including the position of the utterance, the controller 180 may restrict the control responding to the control command corresponding to the utterance.

In this case, the controller 180 may display on the display unit 151 a pop-up window 920 for having the driver select whether to execute the control command corresponding to the utterance or not. As such, the present invention allows the driver to select whether to permit the user positioned in a particular section to take control of other sections.

For example, as depicted in the first and second images of FIG. 9C, if the position of the utterance is included in the third section and the control command corresponding to the utterance is a control command on the first, second, and fourth sections, the controller 180 may display on the display unit 151 a pop-up window 920 for having the driver to select whether to execute the control command corresponding to the utterance. For example, the control command on the first, second, and fourth sections may be air purification (ionizer) in the vehicle.

In another example, if the control command corresponding to the utterance from the section including the back seat is a control command for volume control in the front seat, the controller may display on the display unit 151 a pop-up window for having the user select whether to perform volume control or not. That is, the present invention allows the user to select whether to perform control on a particular position, if a control command involving the particular position is uttered from a position other than the particular position.

In this case, the driver may determine whether to perform the air purification function via the pop-up window 920. That is, the present invention may restrict control to ensure driving safety when it comes to control on sections other than the section including the position of the utterance.

That is, the present invention may restrict overall control of the vehicle for an utterance made in a section other than the section including the driver's seat. As such, the present invention may ensure driving safety by restricting users other than the driver from recklessly controlling the vehicle.

Although not shown, if a control command corresponding to an utterance made in the first section including the driver's seat is a control command for performing control on the sections other than the first section, the controller 180 may execute the control command corresponding to the utterance. That is, for an utterance made in the first section including the driver's seat, unlike for utterances made in the other sections, control may be performed on the sections other than the first section.

For example, if a control command corresponding to an utterance made in the first section including the driver's seat is a control command for lowering the volume on the speakers in the third and fourth sections, the controller may lower the volume on the speakers in the third and fourth sections, based on the control command corresponding to the utterance made in the first section. That is, the present invention may give the driver the overall authority to control the vehicle.

A method for performing control depending on the position of an utterance made in a vehicle has been described above.

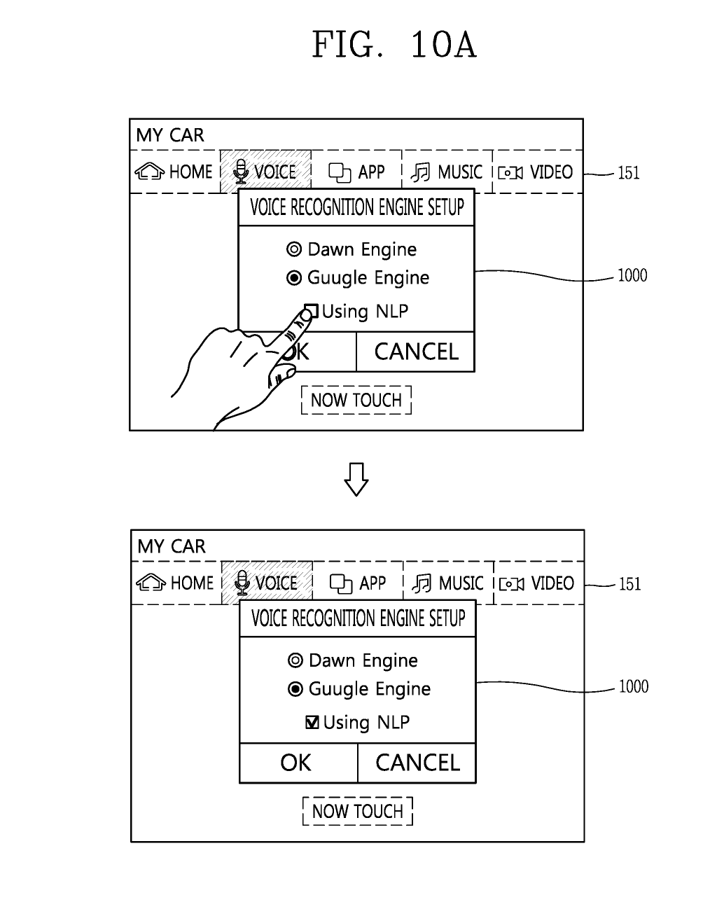

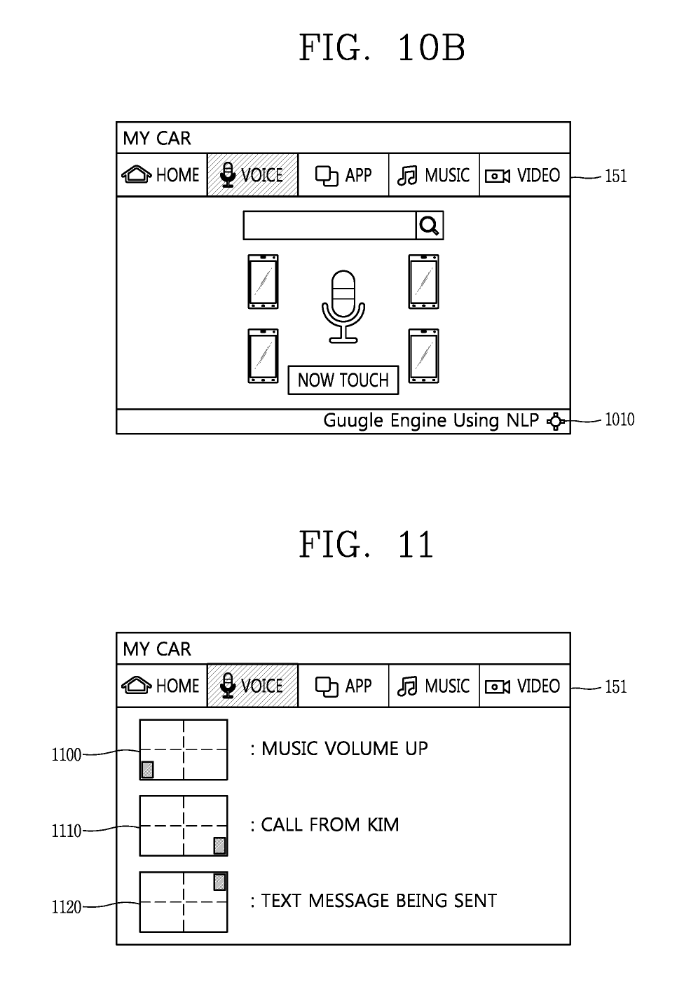

Below is a description of a method for natural language processing in a vehicle driving assist. FIGS. 10A and 10B are conceptual diagrams showing a method for performing natural language processing in a vehicle driving assist.

The controller 180 may perform natural language processing through a voice recognition engine of a mobile terminal interoperating with the vehicle driving assist. The natural language processing may be performed upon a user request. For example, as depicted in the first image of FIG. 10A, the controller 180 may display on the display unit 151 a pop-up window 1000 for selecting to execute a natural language processing function. In this case, as depicted in the second image of FIG. 10A, the natural language processing function may be executed in response to a touch on the pop-up window 1000. In this instance, as depicted in FIG. 10B, a notification 1010 indicating that the natural language processing function is executed may be displayed on the display unit 151.

When the natural language processing function is executed, the controller 180 may perform natural language processing of voice data corresponding to an utterance from a user. For example, the controller 180 may perform a control command for performing an operation for decreasing the temperature of the air conditioner in the back seat of the driver's side, through natural language processing of voice data corresponding to an utterance “Turn down the temperature in the back seat of the driver's side.”

Likewise, the controller 180 may generate a control command for “turning the air conditioner temperature up a degree.” or “turning the air conditioner temperature down a degree.”, through natural language processing of voice data “cold” or “hot”.

Moreover, the controller 180 may generate a control command such as “Keep the air conditioner temperature at 31 degrees or higher.” or “Keep the air conditioner temperature at 18 degrees or lower.”, through natural language processing using adjectives in voice data such as “too cold”, “so cold”, “very cold”, “too hot”, “so hot”, and “very hot”.

Meanwhile, as explained above in FIGS. 9A and 9C, the controller 180 may perform vehicle control based on the position of the utterance, after performing natural language processing of voice data.

For example, the controller 180 may generate a control command for increasing the air conditioner temperature by performing natural language processing of voice data of an utterance “It's cold”. Afterwards, the controller 180 may perform an operation for increasing the air conditioner temperature only in the section including the position of the utterance. For example, if the utterance is made in the assistant driver's seat, the controller 180 may perform an operation for increasing the air conditioner temperature in the assistant driver's seat. That is, the controller 180 may only control vehicle components in a particular section depending on the position of the utterance.

A method for controlling a vehicle by natural language processing has been described above.

Below is a description of a method for displaying result information on a display unit after executing a voice recognition function. FIG. 11 is a conceptual diagram showing a method for displaying result information on a display unit after performing a voice recognition function.

When performing control via a control command corresponding to voice data, the controller 180 may display a control result on the display unit 151. For example, as depicted in FIG. 11, when a control for raising the volume in the back seat of the driver's side is performed, the controller 180 may display a graphical object 1100 representing the back seat of the driver's side and a notification indicating that a control for raising the volume in the back seat has been performed.

Meanwhile, if the result information is privacy information, the controller 180 may display only brief information of the result information. The privacy information may be information relating to personal information. For example, as depicted in FIG. 11, if the result information is information on a specific person, the controller 180 may only display brief information “Text message being sent” on the display unit 151. In this case, the result information may be displayed on the mobile terminal of the specific person. Accordingly, the privacy of users in the vehicle may be protected.

The present invention can process voice data corresponding to an utterance made in a vehicle by using a voice recognition function set up on a plurality of mobile terminals. As such, the present invention can increase the accuracy of the voice recognition function.

Moreover, the present invention can perform control on the inside of the vehicle depending on the position of an utterance in the vehicle. As such, a user in the vehicle is able to control vehicle components in the section they are positioned via voice.

The present invention can be implemented as computer-readable codes in a program-recorded medium. The computer-readable medium may include all types of recording devices each storing data readable by a computer system. Examples of such computer-readable media may include hard disk drive (HDD), solid state disk (SSD), silicon disk drive (SDD), ROM, RAM, CD-ROM, magnetic tape, floppy disk, optical data storage element and the like. Also, the computer-readable medium may also be implemented as a format of carrier wave (e.g., transmission via an Internet). The computer may include the controller 180 of the terminal. Therefore, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

1. A vehicle driving assist comprising:
a display unit;
a microphone configured to receive an utterance from a user in a vehicle;
a wireless communication unit configured to wirelessly communicate with a plurality of mobile terminals positioned in the vehicle;
a position sensing unit for sensing the positions of the plurality of mobile terminals in the vehicle; and
a controller for transmitting voice data corresponding to the utterance received by the microphone to one of the plurality of mobile terminals so as to process the voice data,
wherein the plurality of mobile terminals process voice data through different voice recognition algorithms.

2. The vehicle driving assist of claim 1, wherein the controller controls the display unit to display a plurality of graphical objects respectively representing the plurality of mobile terminals, and displays the graphical object representing the mobile terminal that has received the voice data in such a way as to be visually distinctive from the other graphical objects.

3. The vehicle driving assist of claim 1, wherein the controller detects a mobile terminal for receiving the voice data, among the plurality of mobile terminals, according to a preset condition.

4. The vehicle driving assist of claim 3, wherein the preset condition is a condition relating to at least one among the mobile terminal's resources, the mobile terminal's position, and the mobile terminal's voice recognition engine type.

5. The vehicle driving assist of claim 1, wherein the controller transmits the voice data to a mobile terminal corresponding to one of the plurality of graphical objects selected by the user so that the voice data is processed via the mobile terminal.

6. The vehicle driving assist of claim 1, wherein the controller controls a mobile terminal corresponding to one of the plurality of graphical objects to be restricted from voice reception via the microphone, based on a preset type of touch on the graphical object.

7. The vehicle driving assist of claim 1, wherein a graphical object associated with a function for controlling the microphone to receive an utterance from a particular position in the vehicle is displayed on the display unit, and the controller controls the microphone to receive an utterance from the particular position, based on a touch on the graphical object associated with the microphone control function.

8. The vehicle driving assist of claim 1, wherein the controller processes a control command corresponding to the utterance, based on the position of the utterance.

9. The vehicle driving assist of claim 8, wherein the vehicle is divided into a plurality of virtual sections, and the controller controls a particular section including the position of the utterance, among the plurality of virtual sections, based on the control command corresponding to the utterance.

10. The vehicle driving assist of claim 9, wherein, if the control command corresponding to the utterance is a control command for controlling a section other than the particular section including the position of the utterance, the controller restricts the execution of the control command corresponding to the utterance.

11. The vehicle driving assist of claim 1, wherein the controller displays on the display unit a graphical object representing the position of the utterance.

12. The vehicle driving assist of claim 10, wherein the controller blocks the reception of the utterance, in response to a touch on the graphical object representing the position of the utterance.

13. The vehicle driving assist of claim 1, wherein the controller displays on the display unit vehicle control result information based on a vehicle control command.

14. The vehicle driving assist of claim 13, wherein, if the result information is privacy information, the controller restricts the display of the result information.

15. The vehicle driving assist of claim 1, wherein the plurality of mobile terminals are mobile terminals interoperating with the vehicle driving assist via wireless communication.

16. A method for controlling a vehicle driving assist, comprising:
receiving an utterance from a user in a vehicle;
transmitting voice data corresponding to the utterance to a specific one of a plurality of mobile terminals positioned in the vehicle so as to process the voice data via the specific mobile terminal;
receiving a vehicle control command generated based on the processed voice data from the specific mobile terminal, after transmitting the voice data; and
performing vehicle control based the received vehicle control command.

17. The method of claim 16, wherein the plurality of mobile terminals process voice data through different voice recognition algorithms.

18. The method of claim 16, wherein the specific mobile terminal is determined as selected by the user or according to a preset condition.

19. The method of claim 16, wherein, in the performing of vehicle control, the vehicle is controlled based on the position of the utterance.

20. The method of claim 19, wherein, in the performing of vehicle control, the vehicle components included in a section adjacent to the position of the utterance are controlled.
